(19) United States
(12) Patent Application Publication
(10) Pub. No.: US 2014/0270313 A1
(43) Pub. Date: Sep. 18, 2014

(54) EARPHONE FOLDING DEVICE AND ASSEMBLY THEREOF

(71) Applicant: JETVOX ACOUSTIC CORP., Taoyuan County (TW)

(72) Inventor: To-Teng HUANG, Taoyuan County (TW)

(73) Assignee: Jetvox Acoustic Corp., Taoyuan County (TW)

(21) Appl. No.: 13/891,841

(22) Filed: May 10, 2013

(30) Foreign Application Priority Data
Mar. 13, 2013 (TW) 102204613

(51) Int. Cl. H04R 1/10

(52) U.S. Cl. CPC H04R 1/105
USPC 381/378

(57) ABSTRACT

An earphone folding device and assembly thereof is provided, and includes a first head strap, a second head strap, a connecting base, a pivoting shaft, an elastic member and a button. When the elastic member is in a status of release, the elastic member is abutted against the button, so that the engaging portion is fastened with the engaging block, and the first head strap and the second head strap are positioned in a coaxial position. When the pressing portion is pressed, the elastic member is in a status of compression, so that the engaging portion is detached from the engaging block, and the second head strap is rotated about the pivoting shaft so that the first head strap and the second head strap are positioned in a parallel position.

### CROSS-REFERENCES TO RELATED APPLICATIONS

This non-provisional application claims priority under 35 U.S.C. §119(a) on Patent Application No. 102204613 filed in Taiwan, R.O.C. on 2013/03/13, the entire contents of which are hereby incorporated by reference.

### BACKGROUND OF THE INVENTION

1. Technical Field

The present invention relates to a folding device, and particularly to an earphone folding device and assembly thereof.

2. Related Art

The apparatus for audio-visual entertainment has become popular due to the innovation of related technologies. Recently, commercial products not only provide functions for listening or watching multimedia in high quality, but also provide some functions related to its structure. A headphone is provided as an example, which has a head strap and ear capping members for wearing on the user's head and two ears as supports respectively; the headphone can be hung via the head strap when not in use.

However, the volume of the headphone is typically large due to the head strap and the ear capping members, thereby resulting in an inconvenience for carrying and storing the headphone.

### SUMMARY

In view of this, the present invention proposes an earphone folding device and assembly thereof so as to solve the problems as mentioned.

One embodiment of the present invention provides an earphone folding device which includes a first head strap, a second head strap, a connecting base, a pivoting shaft, elastic member and a button. The button, including a pressing portion and an engaging portion, is disposed in the receiving groove of the connecting base and abutted against the elastic member. When the elastic member is in a status of release, the elastic member is abutted against the button, so that the engaging portion is fastened with the engaging block, and the first head strap and the second head strap are positioned oppositely and defined as in a coaxial position. When the pressing portion is pressed, the elastic member is in a status of compression, so that the engaging portion is detached from the engaging block, and the second head strap is rotated about the pivoting shaft so that the first head strap and the second head strap are positioned in a parallel position wherein the first head strap and the second head strap are folded side by side.

One embodiment of the present invention provides an earphone folding device assembly which includes a first head strap, a second head strap, a connecting base, a pivoting shaft, an elastic member, a button, a first cap member and a second cap member. The button, including a pressing portion and an engaging portion, is disposed in the receiving groove of the connecting base and abutted against the elastic member. When the elastic member is in a status of release, the elastic member is abutted against the button, so that the engaging portion is fastened with the engaging block, and the first head strap and the second head strap are positioned oppositely and defined as in a coaxial position. When the pressing portion is pressed, the elastic member is in a status of compression, so that the engaging portion is detached from the engaging block, and the second head strap is rotated about the pivoting shaft so that the first head strap and the second head strap are positioned in a parallel position wherein the first head strap and the second head strap are folded side by side. Further, the first cap member includes a first rotating segment for connecting to the first head strap and rotating the first cap member multi-directionally; Furthermore, the second cap member includes a second rotating segment for connecting to the second head strap and rotating the second cap member multi-directionally.

Based on the above, the earphone folding device and assembly thereof according to the present invention provides a storage function. Via the using of the button, the first head strap and the second head strap can be adjusted easily; Furthermore, the second head strap can be folded so as to be parallel with the first head strap because of the pivoting shaft. In addition, the first cap member and the second cap member can be rotated in a multidirectional manner because of the first rotating segment and the second rotating segment. Therefore, the volume of the present invention can be reduced and the present invention can be stored easily.

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

### BRIEF DESCRIPTION OF THE DRAWINGS

The present invention will become more fully understood from the detailed description given herein below for illustration only, and thus not limitative of the present invention, wherein:

FIG. 1 is a perspective view of an earphone folding device of the present invention;

FIG. 2 is a partial exploded view of the earphone folding device of a first embodiment of the present invention;

FIG. 3 is another partial exploded view of the earphone folding device of the first embodiment of the present invention;

FIG. 4 is a partially cross-sectional view (1) of the first embodiment of the present invention;

FIG. 5 is a partially cross-sectional view (2) of the first embodiment of the present invention;

FIG. 6 is a partially cross-sectional view (3) of the first embodiment of the present invention;

FIG. 7 is a partially cross-sectional view (4) of the first embodiment of the present invention;

FIG. 8 is a another partially cross-sectional view of the first embodiment of the present invention;

FIG. 9 is a perspective view of an earphone folding device assembly of a second embodiment of the present invention; and

FIG. 10 is another perspective view of the earphone folding device assembly of the second embodiment of the present invention.

### DETAILED DESCRIPTION

Please refer to FIGS. 1-3, in which an earphone folding device of a first embodiment of the present invention is provided, wherein FIG. 1 is a perspective view of an earphone folding device 100 of the present invention; FIG. 2 is a partial exploded view of the earphone folding device 100 of a first embodiment of the present invention; FIG. 3 is another partial exploded view of the earphone folding device 100 of the first embodiment of the present invention. The earphone folding device 100 mainly consists of a first head strap 11, a second head strap 21, a connecting base 31, a pivoting shaft 41, an elastic member 51 and a button 61. As shown in FIGS. 1-3, the earphone folding device 100 is essentially a multimedia accessory of a headphone. In this embodiment, the earphone folding device 100 has a first cap member 81 and a second cap member 91 and can be provided to output a voice source.

Please refer to FIG. 2, in which the first head strap 11 is a semi-arced decoration plate; Furthermore, in this embodiment, the first head strap 11 has a first fastening plate 12 assembled therein. The first fastening plate 12 is an elastic thin plate made of iron so as to be with toughness and capable of being extended or shortened. In this embodiment, the first fastening plate 12 has a first bending portion 13 defined at one end thereof, and a first axial hole 131 is opened through the first bending portion 13.

Please refer to FIG. 2, in which the second bead strap 21 is a semi-arced decoration plate; Furthermore, in this embodiment, the second head strap 21 has a second fastening plate 22 and an engaging block 23 assembled therein. In addition, the second fastening plate 22 is an elastic thin plate made of iron so as to be with toughness and capable of being extended or shortened. In this embodiment, the second fastening plate 22 has a second bending portion 25 defined at one end thereof, and a second axial hole 251 is opened through the second bending portion 25.

Please refer to FIG. 2, in which embodiment the second head strap 21 has a buckling member 26 buckled at one end thereof. The buckling member 26 mainly consists of an upper casing 261 and a lower casing 262.

Please refer to FIG. 2, in which embodiment the engaging block 23 is a cylinder assembled in the buckling member 26; that is to say, the engaging block 23 and the buckling member 26 are separated elements; further, the second fastening plate 22 is disposed between the upper casing 261 and the lower casing 262. In this embodiment, the upper casing 261 has a pivoting portion 263 integrally formed thereon and corresponding to the second bending portion 25. In this embodiment, a pivoting hole 264 is opened through the pivoting portion 263 and corresponds to the second axial hole 251 of the second bending portion 25.

The shape of the engaging block 23 is not limited by the present invention. In some implementation aspects, please refer to FIG. 6, in which the engaging block 23 is a protrusion of the wall of the lower casing 262.

Please refer to FIG. 3, in which the second head strap 21 further has a limiting groove 24 disposed on the pivoting portion 263 of the lower casing 262. In a preferred embodiment, the limiting groove 24 is a semi-arced groove. In this embodiment, the second head strap 21 further has a slot 27 disposed at a side part of the upper casing 261 and the lower casing 262, namely, the slot 27 is essentially a broken hole. Furthermore, the engaging block 23 is positioned in the inner side of the slot 27.

Please refer to FIG. 2, in which embodiment, the connecting base 31 mainly consists of an upper plate 311 and a lower plate 312. In the sectional view, the upper plate 311 and the lower plate 312 are approximately L-shaped respectively, while formed as a C-shaped clamp as a whole. Furthermore, the first fastening plate 12 and the second fastening plate 22 are connected via the connecting base 31. In this embodiment, a receiving groove 32 is opened at one end of the connecting base 31 and the receiving groove 32 has an engaging groove 321 recessed therein, wherein the engaging groove 321 is faced to the button 61; furthermore, a pivoting groove 34 is opened at another end of the connecting base 31, that is to say, the pivoting groove 34 is a hole opened between the upper plate 311 and the lower plate 312, as shown in FIG. 9.

Please refer to FIGS. 2-3, in which embodiment, the connecting base 31 further has a sliding block 33 which is disposed in the limiting groove 24 of the second head strap 21. As shown in FIG. 4, when the sliding block 33 is located at a first position P1 of the limiting groove 24, the first head strap 11 and the second head strap 21 are positioned coaxially with respect to an axis O, namely, positioned oppositely, and defined as in a coaxial position; while when the sliding block 33 is located at a second position P2 of the limiting groove 24, the first head strap 11 and the second head strap 21 are folded side by side and defined as in a parallel position, as shown in FIG. 8.

In some implementation aspects, the limiting groove 24 is opened on the connecting base 31 and the sliding block 33 is assembled on the second head strap 21.

Please refer to FIG. 2, in which the pivoting shaft 41 is an element provided for connecting pivotally. In this embodiment, the pivoting shaft 41 mainly consists of a threaded rod 42 and a bolt 43, wherein the first axial hole 131, the second axial hole 251 and the pivoting hole 264 are passed through in order by the threaded rod 42, so that the threaded rod 42 is threaded with the bolt 43. Under such an arrangement, the pivoting shaft 41 is provided to pass through the connecting base 31 so as to connect the first fastening plate 12 and the second fastening plate 22 pivotally.

Please refer to FIG. 2, in which embodiment, the elastic member 51 is a compressive spring disposed in the receiving groove 32; however, the types of the elastic member 51 are not limited by the present invention. In some implementation aspects, the elastic member 51 can be a rubber member, a reed plate or other elastic elements.

Please refer to FIG. 2 and FIG. 4, in which the button 61 is movably disposed in the receiving groove 32 and one side of the button 61 is abutted against the elastic member 51. In this embodiment, the button 61 mainly consists of a pressing portion 62 and an engaging portion 63, wherein the pressing portion 62 is an extruded portion of the button 61, so that the pressing portion 62 is extruded out of the receiving groove 32 for operation. The engaging portion 63 is a hook-shaped portion and is extended out of a splitting hole 35 which is on a lateral side of the connecting base 31. In this embodiment, the pressing portion 62 and the engaging portion 63 are formed integrally as a whole.

As mentioned above and shown in FIGS. 4-5, the back-and-forth movement of the button 61 drives the movement of the engaging portion 63 in the receiving groove 32; however, the embodiments of the present invention are not limited thereto. In some implementation aspects, as shown in FIGS. 6-7, the button 61 drives the engaging portion 63 via a rotating manner which is achieved by assembling a hinge between the button 61 and the receiving groove 32 for connection, wherein the hinge is disposed between the pressing portion 62 and the engaging portion 63. Therefore, when the pressing portion 62 is pressed, the pressing portion 62 is rotated relative to the hinge, so that the engaging portion 63 is moved oppositely and is further detached from the engaging block 23 which is disposed opposite to the engaging portion 63. In this embodiment, the engaging block 23 is extruded from the wall of the lower casing 262, so that the first head strap 11 and the second head strap 21 can be adjusted to the coaxial position or to the parallel position.

Please refer to FIG. 3, in which the pressing portion 62 further has a recessed groove 621 facing to the receiving groove 32, wherein one end of the elastic member 51 is located in the recessed groove 621. In this embodiment, the engaging groove 321 assembled in the receiving groove 32 is faced to the pressing portion 62, so that another end of the elastic member 51 is located in the engaging groove 321.

Please refer to FIG. 4, in which upon using, namely when the first head strap 11 and the second head strap 21 are positioned coaxially with respect to the axis O, the elastic member 51 is in a status of release, and one end of the elastic member 51 is abutted against the button 61, so that the engaging portion 63 is fastened with the engaging block 23. That is to say, the engaging portion 63 of the button 61 is inserted into the slot 27 and is fastened with the engaging block 23. While referring to FIG. 5, in which when the earphone folding device 100 has to be folded, the pressing portion 62 is pressed so as to lead the elastic member 51 being in a status of compression, so that the engaging portion 63 is detached from the engaging block 23. Therefore, the second head strap 21 is rotated about the pivoting shaft 41 so that the first head strap 11 and the second head strap 21 are positioned in the parallel position.

Please refer to FIGS. 3-4, in which when the first head strap 11 and the second head strap 21 are positioned in the coaxial position, the first bending portion 13 and the second bending portion 25 are stacked together and positioned in the pivoting groove 34. While when the first head strap 11 and the second head strap 21 are positioned in the parallel position, the second bending portion 25 is exposed out of the pivoting groove 34, as shown in FIGS. 8-9.

Please refer to FIG. 1, FIG. 9 and FIG. 10, in which an earphone folding device assembly 200 of a second embodiment of the present invention is provided. The second embodiment is approximately the same of the first embodiment, except that the first cap member 81 further has a first rotating segment 82 and the second cap member 91 further has a second rotating segment 92 in the second embodiment. Furthermore, both the first cap member 81 and the second cap member 91 are capable of rotating clockwise or counterclockwise.

Please refer to FIG. 9, in which embodiment the first cap member 81 is a round-shaped cap and has a voice receiving component (not shown), assembled therein. Further, the first cap member 81 has the first rotating segment 82 for connecting to the first head strap 11. In this embodiment, the first rotating segment 82 mainly consists of two axes, namely, the first main axis 83 and the first vice axis 84.

Please refer to FIGS. 9-10, in which embodiment the first main axis 83 of the first rotating segment 82 is partially connected to the first head strap 11 and is disposed in the coaxial position with the first head strap 11, so that the first cap member 81 is capable of being rotated about the first main axis 83 along a first direction R1 for adjusting.

Please refer to FIGS. 9-10, in which embodiment the first vice axis 84 of the first rotating segment 82 is partially connected to the inner end portion of the first head strap 11, so that the first cap member 81 is rotated about the first vice axis 84 along a second direction R2 so as to adjust one angle between the first cap member 81 and the first head strap 11 for storage and folding, which is achieved by adjusting the first cap member 81 to come close to the first head strap 11. Based on this, the first rotating segment 82 is provided to rotate the first cap member 81 multi-directionally.

Please refer to FIGS. 9-10, in which embodiment the second cap member 91 is a round-shaped cap and has a voice receiving component (not shown), assembled therein.

Further, the second cap member 91 has the second rotating segment 92 for connecting to the second head strap 21. In this embodiment, the second rotating segment 92 mainly consists of two axes, namely, the second main axis 93 and the second vice axis 94.

Please refer to FIGS. 9-10, in which embodiment the second main axis 93 of the second rotating segment 92 is partially connected to the second head strap 21 and is disposed in the coaxial position with the second head strap 21, so that the second cap member 91 is capable of being rotated about the second main axis 93 along a second direction R2 for adjusting.

Please refer to FIGS. 9-10, in which embodiment the second vice axis 94 of the second rotating segment 92 is partially connected to the inner end portion of the second head strap 21, so that the second cap member 91 is rotated about the second vice axis 94 along a second direction R2 so as to adjust another angle between the second cap member 91 and the second head strap 21 for storage and folding, which is achieved by adjusting the second cap member 91 to come close to the second head strap 21. Based on this, the second rotating segment 92 is provided to rotate the second cap member 91 multi-directionally.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An earphone folding device, comprising:
a first head strap, comprising a first fastening plate;
a second head strap, comprising a second fastening plate and a engaging block;
a connecting base, connecting the first fastening plate and the second fastening plate, one end of the connecting base having a receiving groove;
a pivoting shaft, passing through the connecting base and pivoting on the first fastening plate and the second fastening plate;
an elastic member, received in the receiving groove; and
a button, disposed in the receiving groove and abutted against the elastic member, comprising a pressing portion and an engaging portion, wherein, when the elastic member is in a status of release, the elastic member is abutted against the button, so that the engaging portion is fastened with the engaging block, and the first head strap and the second head strap are positioned in a coaxial position; when the pressing portion is pressed, the elastic member is in a status of compression, so that the engaging portion is detached from the engaging block, and the second head strap is rotated about the pivoting shaft so that the first head strap and the second head strap are positioned in a parallel position.

2. The earphone folding device according to claim 1, wherein the second head strap has a limiting groove, the connecting base comprises a sliding block which is disposed in the limiting groove, when the sliding block is located at a first position of the limiting groove, the first head strap and the second head strap are positioned in the coaxial position, when the sliding block is located at a second position of the limiting groove, the first head strap and the second head strap are positioned in the parallel position.

3. The earphone folding device according to claim 1, wherein a pivoting groove is opened at another end of the connecting base, the first fastening plate comprises a first bending portion, the second fastening plate comprises a second bending portion, when the first head strap and the second head strap are positioned in the coaxial position, the first bending portion and the second bending portion are stacked together and positioned in the pivoting groove, when the first head strap and the second head strap are positioned in the parallel position, the second bending portion is exposed out of the pivoting groove.

4. The earphone folding device according to claim 1, wherein the pressing portion has a recessed groove facing to the receiving groove, one end of the elastic member is located in the recessed groove, an engaging groove is assembled in the receiving groove and faces to the pressing portion, and another end of the elastic member is located in the engaging groove.

5. The earphone folding device according to claim 1, wherein the second head strap further has a slot, and the engaging block is positioned in the slot, the engaging portion of the button is inserted into the slot and is fastened with the engaging block.

6. An earphone folding device assembly, comprising:
a first head strap, comprising a first fastening plate;
a second head strap, comprising a second fastening plate and a engaging block;
a connecting base, connecting the first fastening plate and the second fastening plate, one end of the connecting base having a receiving groove;
a pivoting shaft, passing through the connecting base and pivoting on the first fastening plate and the second fastening plate;
an elastic member, received in the receiving groove;
a button, disposed in the receiving groove and abutted against the elastic member, comprising a pressing portion and an engaging portion, wherein, when the elastic member is in a status of release, the elastic member is abutted against the button, so that the engaging portion is fastened with the engaging block, and the first head strap and the second head strap are positioned in a coaxial position; when the pressing portion is pressed, the elastic member is in a status of compression, so that the engaging portion is detached from the engaging block, and the second head strap is rotated about the pivoting shaft so that the first head strap and the second head strap are positioned in a parallel position;
a first cap member, comprising a first rotating segment for connecting to the first head strap and rotating the first cap member in a multidirectional manner; and
a second cap member, comprising a second rotating segment for connecting to the second head strap and rotating the second cap member in a multidirectional manner.

7. The earphone folding device according to claim 6, wherein the second head strap has a limiting groove, the connecting base comprises a sliding block which is disposed in the limiting groove, when the sliding block is located at a first position of the limiting groove, the first head strap and the second head strap are positioned in the coaxial position, when the sliding block is located at a second position of the limiting groove, the first head strap and the second head strap are positioned in the parallel position.

8. The earphone folding device according to claim 6, wherein a pivoting groove is opened at another end of the connecting base, the first fastening plate comprises a first bending portion, the second fastening plate comprises a second bending portion, when the first head strap and the second head strap are positioned in the coaxial position, the first bending portion and the second bending portion are stacked together and positioned in the pivoting groove, when the first head strap and the second head strap are positioned in the parallel position, the second bending portion is exposed out of the pivoting groove.

9. The earphone folding device according to claim 6, wherein the pressing portion has a recessed groove facing to the receiving groove, one end of the elastic member is located in the recessed groove, an engaging groove is assembled in the receiving groove and faces to the pressing portion, and another end of the elastic member is located in the engaging groove.

10. The earphone folding device according to claim 6, wherein the second head strap has a slot, the engaging block is positioned in the slot, the engaging portion of the button is inserted into the slot and is fastened with the engaging block.
